(19) United States
(12) Patent Application Publication
(10) Pub. No.: US 2007/0001604 A1
(43) Pub. Date: Jan. 4, 2007

(54) PLASMA DISPLAY PANEL AND METHOD OF MANUFACTURING THE SAME

(75) Inventor: Yoon Kwan LEE, Gwangmyeong-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/428,041

(22) Filed: Jun. 30, 2006

(30) Foreign Application Priority Data
Jul. 1, 2005 (KR) 10-2005-0059193

(51) Int. Cl. H01J 17/49

(52) U.S. Cl. 313/582

(57) ABSTRACT

A plasma display panel and a method of manufacturing the same are disclosed. The plasma display panel includes a first electrode formed on a first substrate, a barrier rib formed on the first substrate, and at least one second electrode formed on the barrier rib.

This application claims the benefit of the Korean Patent Application No. 10-2005-0059193, filed on Jul. 01, 2005, which is hereby incorporated by reference as if fully set forth herein.

### BACKGROUND OF THE INVENTION

1. Field of the Invention

The present invention relates to a flat panel display apparatus, and more particularly, to a plasma display panel and a method of manufacturing the same.

2. Discussion of the Related Art

Generally, plasma display panels are display apparatuses in which ultraviolet rays generated by gas discharge excite phosphors, thus causing the phosphors to generate visible rays.

Conventional plasma display panels include discharge cells arranged in matrix form. Each of the discharge cells, as shown in FIG. 1, includes an upper substrate 1 providing an image display surface and a lower substrate 3 arranged parallel to the upper substrate 1 by interposing a plurality of barrier ribs 2.

A plurality of sustain electrodes 4 each including a transparent electrode 4a and bus electrode 4b, an upper dielectric layer 6 and a protective film 8 are formed on the upper substrate 1 in this sequence. Also, address electrodes 5 for causing discharge with the sustain electrodes 4 and a lower dielectric layer 7 are formed on the lower substrate 3 in this sequence.

Phosphors 9 for generating visible rays having original colors are applied to side surfaces of the barrier ribs 2 over the lower dielectric layer 7.

The phosphors 9 are excited by vacuum ultraviolet rays of short wavelengths generated upon gas discharge, to thereby generate Red, Green and Blue visible rays.

In the conventional plasma display panels having the above described configuration, the sustain electrodes 4 and upper dielectric layer 6 are individually manufactured via different processes from each other.

Specifically, the sustain electrodes 4 are first formed on the upper substrate 1, and then, the upper dielectric layer 6 is formed over the entire surface of the upper substrate 1 including the sustain electrodes 4.

Thereafter, if the protective film 2 is formed over the upper dielectric layer 6, the manufacture of the upper substrate 1 is completed.

As described above, due to the fact that the sustain electrodes 4 are formed on the upper substrate 1, the conventional plasma display panels have a necessity for the additional upper dielectric layer 6, etc.

Accordingly, the conventional plasma display panels have a complicated manufacturing process, and this becomes a reason of increasing the manufacturing costs due to additional processing equipment and materials, etc.

Further, the conventional plasma display panels suffer from diffusion and yellowing phenomena caused when constituent materials of electrodes react with dielectric and glass components. These phenomena may result in many problems, such as color temperature deterioration and low transmissivity, etc.

Furthermore, the protective film of the conventional plasma display panels has a poor surface smoothness. Accordingly, providing the protective film over the dielectric layer containing organic matter may result in deterioration in electrical properties.

Accordingly, methods of manufacturing the conventional plasma display panels have many restrictions in the manufacture of inexpensive, high-brightness, high-definition and low-power plasma display panels.

### SUMMARY OF THE INVENTION

Accordingly, the present invention is directed to a plasma display panel and a method of manufacturing the same that substantially obviate one or more problems due to limitations and disadvantages of the related art.

An object of the present invention is to provide a plasma display panel in which electrodes are formed over each barrier rib to achieve an increase in opening ratio and brightness, and a method of manufacturing the same.

Another object of the present invention is to provide a plasma display panel and a method of manufacturing the same, which can achieve a simplified overall process via elimination of an upper dielectric layer forming process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: a first electrode formed on a first substrate; a barrier rib formed on the first substrate; and at least one second electrode formed on the barrier rib.

Here, at least one of side surfaces of the second electrode may be obliquely formed.

An angle between the obliquely formed side surface of the second electrode and a corresponding surface of the barrier rib may be an obtuse angle, and the second electrode may have a lower surface area smaller than an upper surface area thereof.

A black layer may be formed between the barrier rib and the second electrode, and the black layer may have a thickness in the range of 2 μm to 3 μm.

In accordance with another aspect of the present invention, there is provided a plasma display panel comprising: a first electrode formed on a first substrate; a dielectric layer formed over the entire surface of the first substrate including the first electrode; a barrier rib formed on the dielectric layer; a phosphor layer formed on a surface of the dielectric layer and side surfaces of the barrier rib; at least one second electrode formed on the barrier rib; and a protective film formed between the second substrate and the second electrode.

Here, the phosphor layer may be formed on a part of each side surface of the barrier rib from the bottom to an intermediate height of the barrier rib.

In accordance with yet another aspect of the present invention, there is provided a method of manufacturing a plasma display panel comprising: preparing a first substrate having a first electrode and a second substrate having a protective film; forming a dielectric layer over the entire surface of the first substrate including the first electrode; forming a barrier rib paste layer and electrode layer over the dielectric layer in this sequence and firing them together; forming a second electrode by etching a predetermined region of the electrode layer to expose the barrier rib paste layer; forming a barrier rib by etching the exposed barrier rib paste layer to expose the dielectric layer; dividing the second electrode into a plurality of electrodes by removing a predetermined region of the second electrode to expose the barrier rib; forming a phosphor layer over the exposed dielectric layer and on a part of each side surface of the barrier rib; and bonding the second substrate having the protective film onto the second electrode.

Here, in the formation of the second electrode, the etching of the electrode layer may be performed by use of an anisotropy etching, and preferably, an upper surface of the electrode layer may have a smaller etching area than a lower surface thereof.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a conventional plasma display panel;

FIG. 2 is a view illustrating a plasma display panel according to the present invention; and

FIGS. 3A to 3H are process sectional views illustrating the manufacture of the plasma display panel according to the present invention.

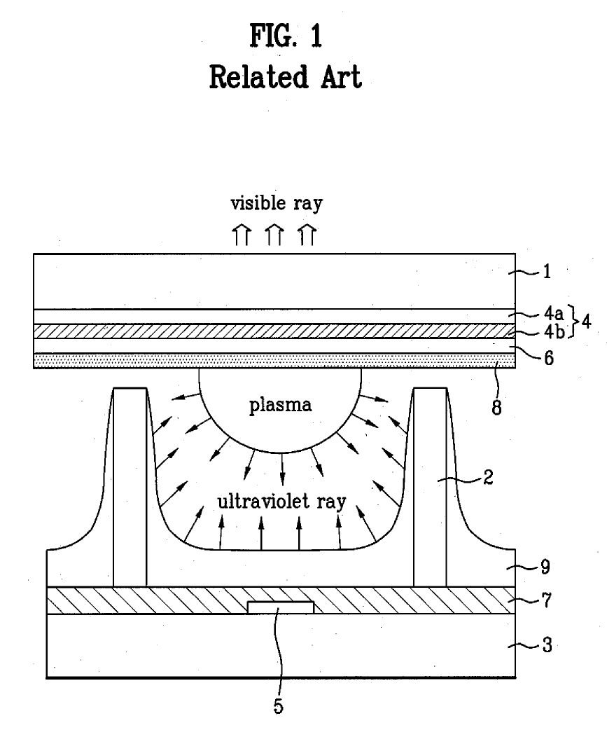

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

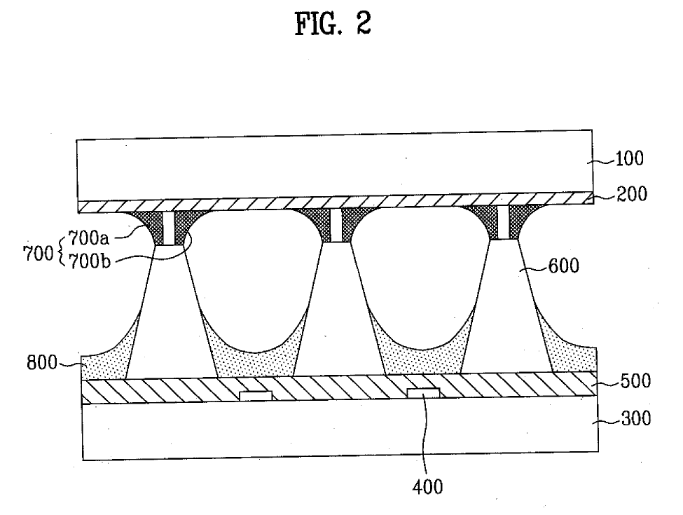

FIG. 2 is a view illustrating a plasma display panel according to the present invention. As shown in FIG. 2, the plasma display panel includes an upper substrate 100 and lower substrate 300 arranged to face each other.

A protective film 200 covers one of opposite surfaces of the upper substrate 100, i.e. a surface facing the lower substrate 300.

A first electrode 400 is formed on the lower substrate 300 over a light-emitting region of the lower substrate 300, to face the upper substrate 100. Also, a dielectric layer 500 is formed over the entire surface of the lower substrate 300 including the first electrode 400.

Here, the first electrode 400 may be at least one address electrode.

The plasma display panel further includes a barrier rib 600 formed on the dielectric layer 500 over a non-light-emitting region.

The barrier rib 600 protrudes toward the upper substrate 100 only from the non-light emitting region, in order to separate light-emitting cells constituting the light-emitting region.

At least one second electrode 700 is formed on the barrier rib 600.

Here, at least one of side surfaces of the second electrode 700 may be obliquely formed.

Preferably, at least one of the side surfaces of the second electrode 700 facing the light-emitting region may be obliquely formed.

In this case, an angle defined between the obliquely formed side surface of the second electrode 700 and a corresponding surface of the barrier rib 600 may be an obtuse angle.

Preferably, the second electrode 700 may be configured in such a manner that a lower surface area thereof is smaller than an upper surface area thereof.

Here, the second electrode 700 may include at least one scan electrode 700a and at least one sustain electrode 700b.

Specifically, one scan electrode 700a and one sustain electrode 700b may be arranged on each barrier rib 600 to be spaced apart from each other by a predetermined distance. In this case, side surfaces of the scan electrode 700a and sustain electrode 700b facing each other may be vertically formed, and side surfaces of both the electrodes 700a and 700b facing the light-emitting region may be obliquely formed.

The reason why the side surfaces of the second electrode 700 facing the light-emitting region are obliquely formed is to facilitate generation of address discharge and sustain discharge within the light-emitting region.

If necessary, a black layer may be formed between the barrier rib 600 and the second electrode 700, in order to increase the overall contrast ratio of the panel.

Preferably, the black layer has a thickness of approximately 2 μm to 3 μm, and the second electrode 700 has a thickness of approximately 10 μm to 20 μm.

In addition, a phosphor layer 800 is formed on side surfaces of the barrier rib 600 and on the dielectric layer 500 over the light-emitting region.

Preferably, the phosphor layer 800 may be formed only on a part of each side surface of the barrier rib 600 from the bottom to an intermediate height of the barrier rib 600.

The reason why providing roughly half of each side surface of the barrier rib 600 with the phosphor layer 800 is to space the phosphor layer 800 apart from the second electrode 700 by a desired distance. This preferably has the effect of preventing deterioration of the phosphor layer 800 even when strong discharge is generated between the second electrode 700 and the upper substrate 100.

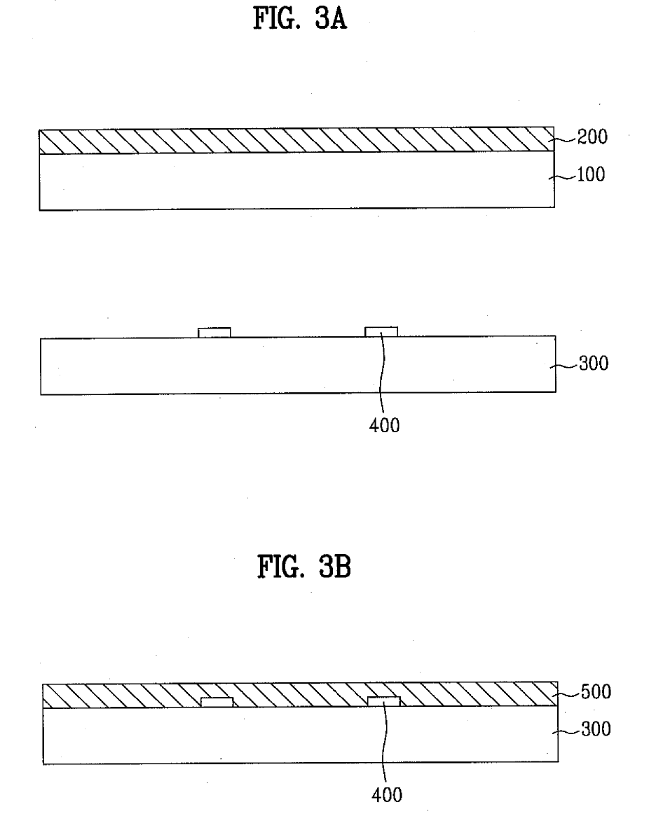

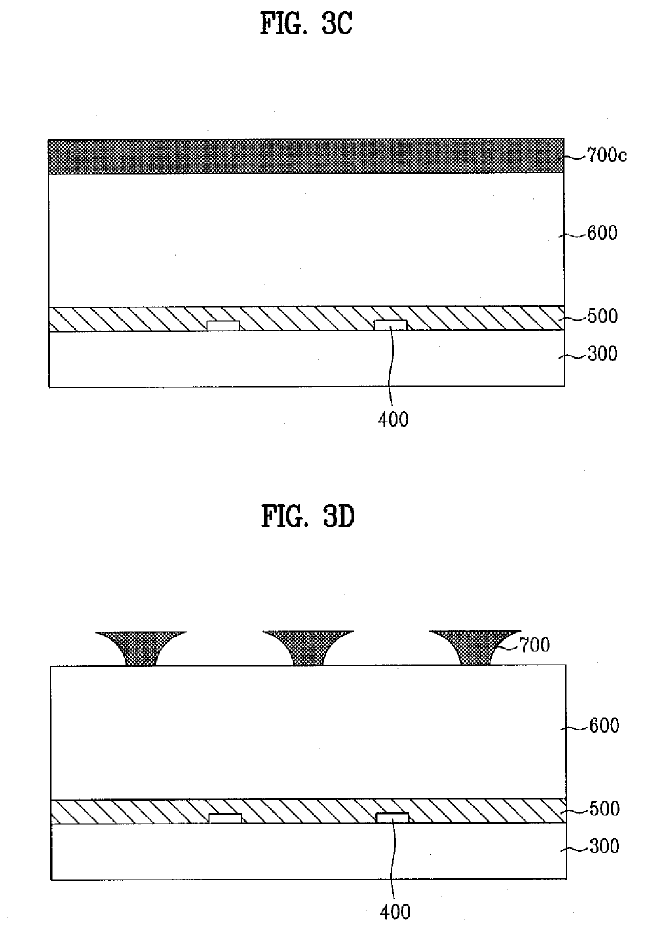

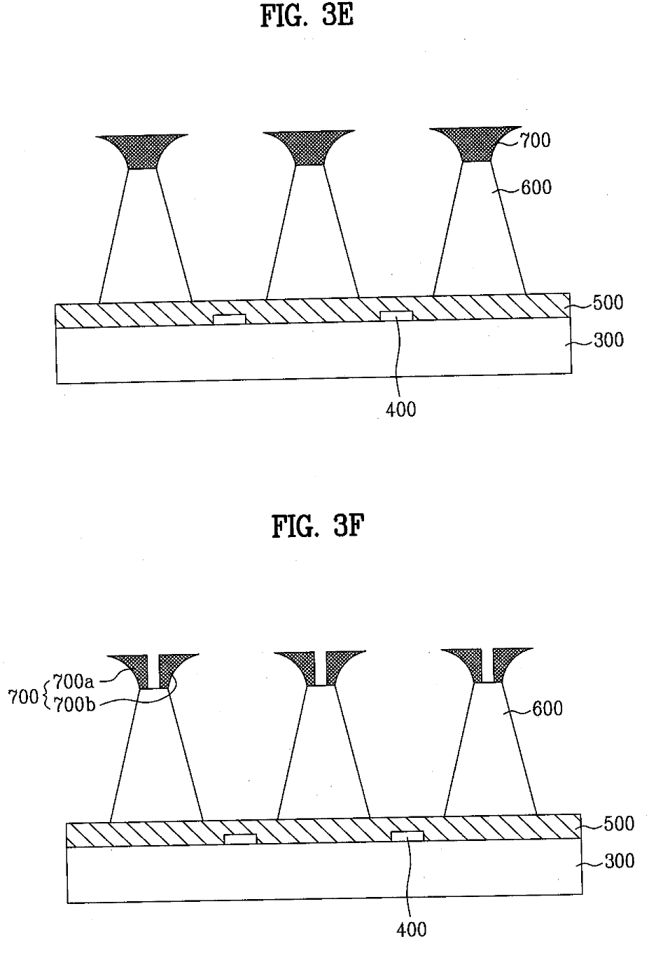

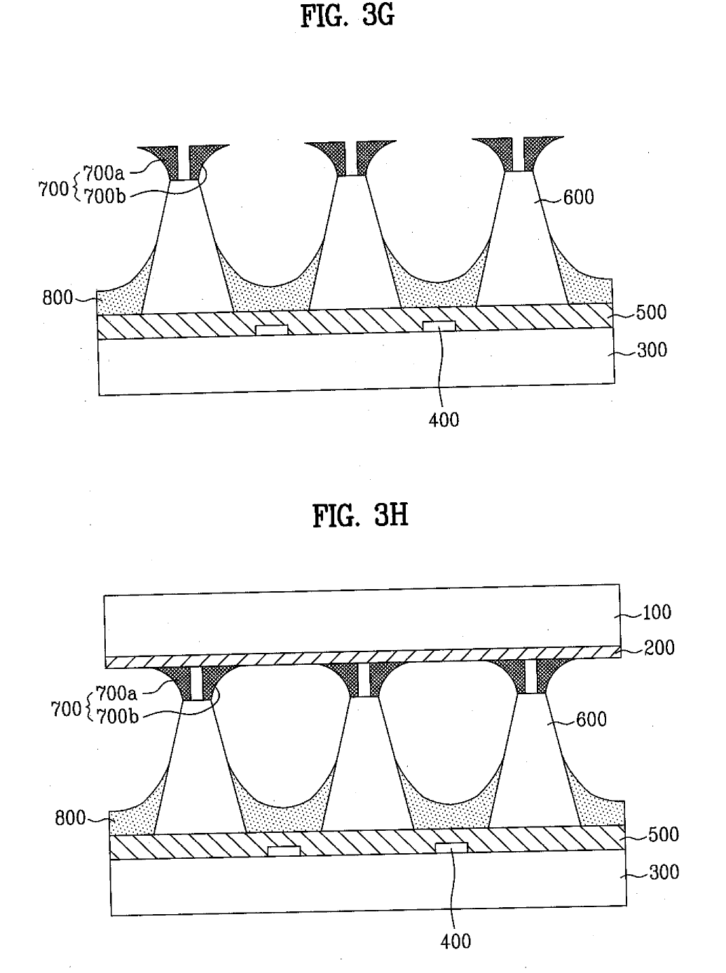

FIGS. 3A to 3H are process sectional views illustrating the manufacture of the plasma display panel according to the present invention.

Referring firstly to FIG. 3A, the first electrode 400 is formed on the lower substrate 300, and the protective film 200 is formed on the upper substrate 100.

Here, the protective film 200 may have a thickness of approximately 8000 Å, and be made of MgO.

Referring secondly to FIG. 3B, the dielectric layer 500 is formed over the entire surface of the lower substrate 300 including the first electrode 400.

Here, the dielectric layer 500 may have a thickness of approximately 20 μm.

Referring thirdly to FIG. 3C, a barrier rib paste layer 600a and an electrode layer 700c are formed over the dielectric layer 500 in this sequence, and are fired together.

Here, the barrier rib paste layer 600a may contain glass powder containing ceramic-based oxides mixed therein, and have a thickness of approximately 120 μm to 150 μm.

Also, the barrier rib paste layer 600a may contain several tens of wt % of highly reflective ceramic oxide, and the highly reflective ceramic oxide may be TiO₂ or ZrO₂.

The electrode layer 700c may have a thickness of approximately 10 μm to 20 μm.

The firing temperature is preferably in the range of approximately 500° C. to 600° C.

If necessary, to increase the overall contrast ratio of the panel, a black layer (not shown) may be formed between the barrier rib paste layer 600a and the electrode layer 700c.

Preferably, the black layer may have a thickness of approximately 2 μm to 3 μm.

Referring fourthly to FIG. 3D, a predetermined region of the electrode layer 700c is etched to expose the barrier rib paste layer 600a, to form the second electrode 700.

Here, the electrode layer 700c may be etched by use of an anisotropy etching such that at least one of the side surfaces of the resulting second electrode 700 facing the light-emitting region is obliquely formed.

Specifically, the electrode layer 700c is etched in such a manner that an upper surface thereof has an etching area smaller than a lower surface thereof. As a result, the resulting second electrode 700 has a lower surface area smaller than an upper surface area thereof.

Referring fifthly to FIG. 3E, the exposed barrier rib paste layer 600a is etched to expose the dielectric layer 500, to form the barrier rib 600.

The side surfaces of the barrier rib 600 may be vertically or obliquely formed.

Referring sixthly to FIG. 3F, a predetermined region of the second electrode 700 is removed to expose an upper surface of the barrier rib 600, to form the scan electrode 700a and sustain electrode 700b.

When the second electrode 700 is partially removed, it is desirable that a portion of the barrier rib 600 in contact with the second electrode 700 be simultaneously removed to achieve an efficient insulation between the scan electrode 700a and the sustain electrode 700b.

As a result, one scan electrode 700a and one sustain electrode 700b are arranged on each barrier rib 600 to be spaced apart from each other by a predetermined distance. Also, side surfaces of the scan electrode 700a and sustain electrode 700b facing each other may be vertically formed, and other side surfaces of the electrodes 700a and 700b facing the light-emitting region may be obliquely formed.

The reason why the side surfaces of the second electrode 700 facing the light-emitting region are obliquely formed is to facilitate generation of address discharge and sustain discharge within the light-emitting region.

Referring seventhly to FIG. 3G, the phosphor layer 800 is formed on the side surfaces of the barrier rib 600 and on the exposed dielectric layer 500.

Preferably, the phosphor layer 800 may be formed on a part of each side surface of the barrier rib 600 from the bottom to an intermediate height of the barrier rib 600.

The reason why providing roughly half of each side surface of the barrier rib 600 with the phosphor layer 800 is to space the phosphor layer 800 apart from the second electrode 700 by a desired distance. This preferably has the effect of preventing deterioration of the phosphor layer 800 even when strong discharge is generated between the second electrode 700 and the upper substrate 100.

Referring finally to FIG. 3H, as the upper substrate 100 having the protective film 200 is bonded to the second electrode 700, the manufacture of the plasma display panel is completed.

As apparent from the above description, the present invention provides a plasma display panel and a method of manufacturing the same having the following effects.

Firstly, in the plasma display panel of the present invention, an upper substrate thereof is provided with a protective film only. This has the effects of simplifying a substrate manufacturing process, reducing material costs and achieving a considerable increase in transmissivity of visible rays.

Secondly, providing the protective film at a flat plane of the upper substrate has the effect of achieving high crystallinity, resulting in improvements in secondary electron discharge and brightness characteristics.

Thirdly, the plasma display panel of the present invention can achieve an improved opening ratio as compared to the prior art. This is very advantageous in the views of brightness and efficiency.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel having a light emitting cell between first and second substrates facing each other, comprising:
a first electrode formed on the first substrate;
a barrier rib formed on the first substrate; and
at least one second electrode formed on the barrier rib.

2. The panel according to claim 1, wherein at least one of side surfaces of the second electrode is obliquely formed.

3. The panel according to claim 2, wherein at least one of the side surfaces of the second electrode facing the light emitting cell is obliquely formed.

4. The panel according to claim 3, wherein an angle defined between the obliquely formed side surface of the second electrode and a corresponding surface of the barrier rib is an obtuse angle.

5. The panel according to claim 1, wherein the second electrode has a lower surface area smaller than an upper surface area thereof.

6. The panel according to claim 1, wherein the first electrode includes at least one address electrode, and the second electrode includes at least one scan electrode and at least one sustain electrode.

7. The panel according to claim 6, wherein one scan electrode and one sustain electrode are arranged on each barrier rib to be spaced apart from each other by a predetermined distance, and side surfaces of the scan electrode and sustain electrode facing each other are vertically formed, and side surfaces of the scan and sustain electrodes facing the light emitting cell are obliquely formed.

8. The panel according to claim 1, wherein a black layer is formed between the barrier rib and the second electrode.

9. The panel according to claim 8, wherein the black layer has a thickness in the range of 2 μm to 3 μm.

10. The panel according to claim 1, wherein the second electrode has a thickness in the range of 10 μm to 20 μm.

11. A plasma display panel having a light emitting cell between first and second substrates facing each other, comprising:
a first electrode formed on the first substrate;
a dielectric layer formed over the entire surface of the first substrate including the first electrode;
a barrier rib formed on the dielectric layer;
a phosphor layer formed on a surface of the dielectric layer and on side surfaces of the barrier rib;
at least one second electrode formed on the barrier rib; and
a protective film formed between the second substrate and the second electrode.

12. The panel according to claim 11, wherein the phosphor layer is formed on a part of each side surface of the barrier rib from the bottom to an intermediate height of the barrier rib.

13. The panel according to claim 11, wherein a black layer is formed between the barrier rib and the second electrode.

14. A method of manufacturing a plasma display panel comprising:
preparing a first substrate having a first electrode and a second substrate having a protective film;
forming a dielectric layer over the entire surface of the first substrate including the first electrode;
forming a barrier rib paste layer and electrode layer over the dielectric layer in this sequence and firing them together;
forming a second electrode by etching a predetermined region of the electrode layer to expose the barrier rib paste layer;
forming a barrier rib by etching the exposed barrier rib paste layer to expose the dielectric layer;
dividing the second electrode into a plurality of electrodes by removing a predetermined region of the second electrode to expose the barrier rib;
forming a phosphor layer over the exposed dielectric layer and on a part of each side surface of the barrier rib; and
bonding the second substrate having the protective film onto the second electrode.

15. The method according to claim 14, wherein, in the formation of the second electrode, the etching of the electrode layer is performed by use of an anisotropy etching.

16. The method according to claim 14, wherein, in the formation of the second electrode, an upper surface of the electrode layer has an etching region smaller than that of a lower surface of the electrode layer.

17. The method according to claim 14, wherein, in the sequential formation and firing of the barrier rib paste layer and electrode layer on the dielectric layer, a firing temperature is in the range of 500° C. to 600° C.

18. The method according to claim 14, wherein the electrode layer has a thickness in the range of 10 μm to 20 μm.

19. The method according to claim 14, wherein, in the division of the second electrode into the plurality of electrodes via removal of a predetermined region of the second electrode for exposing the barrier rib, an exposed portion of the barrier rib is removed by a predetermined depth simultaneously with the removal of the second electrode, to achieve an insulation between the divided electrodes.

20. The method according to claim 14, wherein the barrier rib contains glass powder containing ceramic-based oxides mixed therein, and the protective film is made of MgO.

21. A method of manufacturing a plasma display panel comprising forming a photosensitive barrier rib paste on a substrate and exposing the photosensitive barrier rib paste to light so as to form a barrier rib, wherein the barrier rib paste contains several tens of wt % of highly reflective ceramic oxide.

22. The method according to claim 21, wherein the highly reflective ceramic oxide is TiO₂ or ZrO₂.
